(19) United States
(12) Patent Application Publication
(10) Pub. No.: US 2023/0239070 A1
(43) Pub. Date: Jul. 27, 2023

(54) QUADRATURE AMPLITUDE MODULATION (QAM) TRANSMISSION FOR NARROWBAND INTERNET-OF-THINGS (NBIoT)

(71) Applicant: Lenovo (Beijing) Ltd., Beijing (CN)

(72) Inventors: Zhi Yan, Xicheng District (CN); Hongmei Liu, Changping District (CN); Yuantao Zhang, Dongcheng District (CN); Haipeng Lei, Haidan District (CN); Haiming Wang, Xicheng District (CN)

(73) Assignee: Lenovo (Beijing) Ltd., Beijing (CN)

(21) Appl. No.: 17/787,511

(22) PCT Filed: Jan. 10, 2020
(86) PCT No.: PCT/CN2020/071469

§ 371 Date: Jun. 20, 2022

(51) Int. Cl. H04L 1/00; H04L 27/36

(52) U.S. Cl. CPC H04L 1/0009; H04L 1/0003; H04L 27/36; H04L 1/0023

(57) ABSTRACT

Methods and apparatuses for transmitting or receiving data for NBIoT supporting 16QAM modulation are disclosed. A method comprises receiving a control signal, wherein the control signal includes a MCS index and a resource assignment index; and receiving a control signal, wherein the control signal includes a MCS index and a resource assignment index, wherein the transport block size is determined by a combination of a transport block size index and the resource assignment index, and the transport block size index is determined by at least one of the MCS index and the resource assignment index.

### FIELD

The subject matter disclosed herein generally relates to wireless communications, and more particularly relates to 16QAM transmission for NBIoT.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Orthogonal Frequency Division Multiplexing (OFDM), Radio Resource Control (RRC), Reference Signal (RS), Single Carrier Frequency Division Multiple Access (SC-FDMA), Time-Division Duplex (TDD), Time Division Multiplex (TDM), User Entity/Equipment (Mobile Terminal) (UE), Universal Mobile Telecommunications System (UMTS), Worldwide Interoperability for Microwave Access (WiMAX), Internet-of-Things (IoT), Narrowband Internet-of-Things (NB-IoT or NBIoT), Long Term Evolution (LTE), Narrowband (NB), Narrowband Primary Synchronization Signal (NPSS), Narrowband Secondary Synchronization Signal (NSSS), Narrowband Physical Broadcast Channel (NPBCH or NB-PBCH), System Information (SI), System Information Block (SIB), System Information Block Type1-NB (NB-SIB1), Physical Downlink Shared Channel (PDSCH), Narrowband Physical Downlink Shared Channel (NPDSCH), Physical Uplink Shared Channel (PUSCH), Narrowband Physical Uplink Shared Channel (NPUSCH), Physical Resource Block (PRB), Universal Mobile Telecommunications System (UMTS), Evolved-UMTS Terrestrial Radio Access (E-UTRA or EUTRA), Binary Phase Shift Keying (BPSK), Quadrature Phase Shift Keying (QPSK), Quadrature Amplitude Modulation (QAM), Transport Block Size (TBS), modulation and coding scheme (MCS), Downlink Control Information (DCI).

In NB-IoT Release 16, for NPDSCH, when a coded data is transmitted from the base unit (e.g. gNB) to the remote unit (e.g. UE), the number of resource unit (N_{SF}) and the subcarriers to be used in time and frequency domain are determined as follows:

Table 1 indicates the number of resource units (N_{SF}) being determined by the resource assignment (I_{SF}). The resource assignment (I_{SF}) is indicated with 3 bits by the corresponding control signal (e.g., DCI format N1). The resource unit for NPDSCH is 1 ms for time domain and 1 PRB (12 subcarriers) in frequency domain.

TABLE 1

| I_{SF} | N_{SF} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used are a total of 12 subcarriers (each subcarrier is 15 KHz).

The coded data is transmitted with a transport block size (TBS), and transmitted by using a modulation type such as QPSK. The modulation type is associated with a modulation order (Qₘ). For example, the modulation order (Qₘ) of QPSK is 2. In the present application, the modulation order (Qₘ) represents the modulation type.

TBS is determined by TBS index (I_{TBS}) and the resource assignment (I_{SF}). TBS index (I_{TBS}) is determined by MCS (modulation and coding scheme) index (I_{MCS}). When QPSK (Qₘ=2) is assumed as the modulation type, I_{TBS}=I_{MCS}. The MCS index (I_{MCS}) is indicated with 4 bits by the corresponding control signal (e.g., DCI format N1).

Table 2 indicates the Transport block size (TBS) table for NPDSCH in NB-IoT Release 16.

TABLE 2

| | I_{SF} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1032 |
| 7 | 104 | 224 | 328 | 472 | 584 | 680 | 968 | 1224 |
| 8 | 120 | 256 | 392 | 536 | 680 | 808 | 1096 | 1352 |
| 9 | 136 | 296 | 456 | 616 | 776 | 936 | 1256 | 1544 |
| 10 | 144 | 328 | 504 | 680 | 872 | 1032 | 1384 | 1736 |
| 11 | 176 | 376 | 584 | 776 | 1000 | 1192 | 1608 | 2024 |
| 12 | 208 | 440 | 680 | 904 | 1128 | 1352 | 1800 | 2280 |
| 13 | 224 | 488 | 744 | 1032 | 1256 | 1544 | 2024 | 2536 |

In Table 2, I_{TBS} ranges from 0 to 13.

In NB-IoT Release 16, for NPUSCH, when a coded data is transmitted from the remote unit (e.g. UE) to the base unit (e.g. gNB), the number of resource unit (N_{RU}) and the subcarriers to be used are determined as follows:

Table 3 indicates the number of resource units (N_{RU}) being determined by the resource assignment (I_{RU}). The resource assignment (I_{RU}) is indicated with 3 bits by the corresponding control signal (e.g., DCI format N1). The resource unit for NPUSCH is determined by the subcarrier spacing of the NPUSCH data. For example, for 15 KHz subcarrier spacing, the resource unit of NPUSCH data transmission is 16 slots (8 ms) in time domain and 1 subcarrier in frequency domain, or 8 slots (4 ms) in time domain and 3 subcarriers in frequency domain.

TABLE 3

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used for NPUSCH data transmission are different for different subcarrier spacings. For subcarrier spacing of 3.75 KHz, only single-tone is supported and one of 48 subcarriers is used. The used subcarrier can be indicated by a 6-bits field. For subcarrier spacing of 15 KHz, both single-tone and multiple-tone are supported. One or three or six or twelve of twelve subcarriers is used. The subcarriers to be used may be indicated as indicated in Table 4.

TABLE 4

| Subcarrier | |
|---|---|
| indication field | |
| (I_{SC}) | Set of Allocated subcarrier(s) (N_{SC}) |
| 0-11 | I_{SC} |
| 12-15 | 3 (I_{SC} - 12) + {0, 1, 2} |
| 16-17 | 6 (I_{SC} - 16) + {0, 1, 2, 3, 4, 5} |
| 18 | {0, 1, 2, 3, 4, 5, 6, 7, 8, 9, 10, 11} |
| 19-63 | Reserved |

TBS is determined by TBS index (I_{TBS}) and resource assignment (I_{RU}).

Table 5 indicates the Transport block size (TBS) table for NPUSCH in NB-IoT Release 16.

TABLE 5

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |

In Table 5, I_{TBS} ranges from 01 to 13.

For single-tone, when N_{sc}^{RU}=1, modulation order (Qₘ) and TBS index (I_{TBS}) are determined by MCS index (I_{MCS}), as shown in Table 6. It can be seen from Table 6 that only BPSK (i.e. Qₘ=1) and QPSK (i.e. Qₘ=2) are supported.

TABLE 6

| MCS Index | Modulation | |
|---|---|---|
| (I_{MCS}) | Order (Qₘ) | TBS Index(I_{TBS}) |
| 0 | 1 | 0 |
| 1 | 1 | 2 |
| 2 | 2 | 1 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 2 | 10 |

For multiple-tone, when N_{sc}^{RU}>1, modulation order (Qₘ)=2 is assumed. In this condition, I_{TBS} I_{MCS}.

In the above TBS determination for NBIoT Release 16, only modulation order (Qₘ)=1 or 2 (i.e. modulation type of BPSK or QPSK) is supported. In NBIoT Release 17, modulation type of 16QAM (modulation order (Qₘ)=4) will be supported for uplink and downlink data transmission.

### BRIEF SUMMARY

Methods and apparatuses for transmitting or receiving data for NBIoT supporting 16QAM modulation are disclosed.

In one embodiment, a method comprises receiving a control signal, wherein the control signal includes a MCS index and a resource assignment index; and receiving a control signal, wherein the control signal includes a MCS index and a resource assignment index, wherein the transport block size is determined by a combination of a transport block size index and the resource assignment index, and the transport block size index is determined by at least one of the MCS index and the resource assignment index.

In one embodiment, the transport block size index is further determined by a scaling factor. The scaling factor may be determined by the resource assignment index.

In another embodiment, the modulation type is determined by the MCS index and the resource assignment index. In particular, the modulation type may be further determined by a scaling factor. The scaling factor may be determined by the resource assignment index.

In some embodiment, the number of resource units is determined by the resource assignment index and the modulation type.

In some embodiment, the control signal further includes a first field, the first field indicates the modulation type and the set of subcarrier(s). In particular, the first field includes 6 bits, and at least the state values 19 to 25 indicate the modulation type being 16QAM.

In one embodiment, a base unit comprises a transceiver, the transceiver is configured to: transmit a control signal, wherein the control signal includes a MCS index and a resource assignment index; and receive or transmit a coded data on a number of resource units and a set of subcarrier(s), wherein the coded data is associated with a modulation type and a transport block size, wherein the transport block size is determined by a combination of a transport block size index and the resource assignment index, and the transport block size index is determined by at least one of the MCS index and the resource assignment index.

In another embodiment, a method comprises transmitting a control signal, wherein the control signal includes a MCS index and a resource assignment index; and receiving or transmitting a coded data on a number of resource units and a set of subcarrier(s), wherein the coded data is associated with a modulation type and a transport block size, wherein the transport block size is determined by a combination of a transport block size index and the resource assignment index, and the transport block size index is determined by at least one of the MCS index and the resource assignment index.

In yet another embodiment, a remote unit comprises a transceiver, the transceiver is configured to: receive a control signal, wherein the control signal includes a MCS index and a resource assignment index; and transmit or receive a coded data on a number of resource units and a set of subcarrier(s), wherein the coded data is associated with a modulation type and a transport block size, wherein the transport block size is determined by a combination of a transport block size index and the resource assignment index, and the transport block size index is determined by at least one of the MCS index and the resource assignment index.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The first embodiment is related to the support of 16QAM for NPDSCH of release 17.

As in Release 16, the number of resource units (N_{SF}) is determined by the resource assignment (I_{SF}), as indicated in Table 7.

TABLE 7

| I_{SF} | N_{SF} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used are a total of 12 subcarriers (each subcarrier is 15 KHz).

TBS is determined by TBS index (I_{TBS}) and the resource assignment (I_{SF}). The maximal TBS can be increased to two times of legacy value for NPDSCH. The maximal TBS index (I_{TBS}) can be extended to 20 or 21. The resource assignment (I_{SF}) remains as ranging from 0 to 7. Table 8 indicates the Transport block size (TBS) table for NPDSCH for support of 16QAM, in which I_{TBS} ranges from 0 to 21. If the maximum TBS index (I_{TBS}) is extended to 20, the last line of the Table 8 is omitted.

TABLE 8

| | I_{SF} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |
| 14 | 256 | 552 | 840 | 1128 | 1416 | 1736 | 2280 | 2856 |
| 15 | 280 | 600 | 904 | 1224 | 1544 | 1800 | 2472 | 3112 |
| 16 | 328 | 632 | 968 | 1288 | 1608 | 1928 | 2600 | 3240 |
| 17 | 336 | 696 | 1064 | 1416 | 1800 | 2152 | 2856 | 3624 |
| 18 | 376 | 776 | 1160 | 1544 | 1992 | 2344 | 3112 | 4008 |
| 19 | 408 | 840 | 1288 | 1736 | 2152 | 2600 | 3496 | 4264 |
| 20 | 440 | 904 | 1384 | 1864 | 2344 | 2792 | 3752 | 4584 |
| 21 | 488 | 1000 | 1480 | 1992 | 2472 | 2984 | 4008 | 4968 |

As can be seen from Table 8, legacy TBS table (i.e. I_{TBS} from 0 to 13) is kept for compatibility with Release 16. That is, UE in Release 16 can reuse legacy TBS table (I_{TBS} from 0 to 13). New items (i.e. I_{TBS} from 14 to 21) are added for the support of T6QAM (i.e. Qₘ=4).

The modulation order (Qₘ) and the TBS index (I_{TBS}) are determined by MCS index (I_{MCS}). In release 16, MCS index (I_{MCS}) are represented by 4 bits. In release 17, MCS index (I_{MCS}) may also be represented by 4 bits. There can be two options for the number of MCS indices. For option 1, the same number as the number of MCS indices in release 16 is used, i.e. 14 MCS indices are used. For option 2, the number of MCS indices is extended to 16, i.e. 16 MCS indices (that can still be represented by 4 bits) are used.

The modulation order (Qₘ) is determined by MCS index (I_{MCS}). There can be two options of determining the modulation order (Qₘ) by the MCS index (I_{MCS}). For option A1, QPSK (Qₘ=2) is used when I_{TBS} is equal to 0 to 13; and T6QAM (Qₘ=4) is used when I_{TBS} is equal to 14 to 20 (for option 1) or 14 to 21 (for option 2). For option A2, QPSK (Qₘ=2) is used when I_{TBS} is equal to 0 to 9; and 16QAM (Qₘ=4) is used when I_{TBS} is equal to 10 to 20 (for option 1) or 10 to 21 (for option 2).

The TBS index (I_{TBS}) is determined by MCS index (I_{MCS}). There can be two options of determining TBS index (I_{TBS}) by the MCS index (I_{MCS}). For option B1, the TBS index is selected from a total of 21 TBS indices (I_{TBS}=0 to 20). For option B2, the TBS index is selected from a total of 22 TBS indices (I_{TBS}=0 to 21). Incidentally, when I_{TBS}=21 (i.e. in the condition of a total of 22 TBS indices), the code rate for some of the TBSs is slightly larger than 0.93, especially for inband operation mode of NBIoT.

Table 9 indicates the determination of the modulation order (Qₘ) and the TBS index (I_{TBS}) by MCS index (I_{MCS}) in option 1 (i.e. a total of 14 MCS indices).

TABLE 9

| | Option A1 | Option A2 | Option B1 | Option B2 |
|---|---|---|---|---|
| MCS | Modulation | Modulation | TBS | TBS |
| Index | Order | Order | Index | Index |
| (I_{MCS}) | (Qₘ) | (Qₘ) | (I_{TBS}) | (I_{TBS}) |
| 0 | 2 | 2 | 0 | 0 |
| 1 | 2 | 2 | 2 | 2 |
| 2 | 2 | 2 | 3 | 3 |
| 3 | 2 | 2 | 5 | 5 |
| 4 | 2 | 2 | 6 | 6 |
| 5 | 2 | 2 | 8 | 8 |
| 6 | 2 | 2 | 9 | 9 |
| 7 | 2 | 4 | 11 | 11 |
| 8 | 2 | 4 | 12 | 13 |
| 9 | 4 | 4 | 14 | 14 |
| 10 | 4 | 4 | 15 | 16 |
| 11 | 4 | 4 | 17 | 17 |
| 12 | 4 | 4 | 18 | 19 |
| 13 | 4 | 4 | 20 | 20 |

Table 10 indicates the determination of the modulation order (Qₘ) and the TBS index (I_{TBS}) by MCS index (I_{MCS}) in option 2 (i.e. a total of 16 MCS indices).

TABLE 10

| | Option A1 | Option A2 | Option B1 | Option B2 |
|---|---|---|---|---|
| | Modulation | Modulation | TBS | TBS |
| MCS | Order | Order | Index | Index |
| Index(I_{MCS}) | (Qₘ) | (Qₘ) | (I_{TBS}) | (I_{TBS}) |
| 0 | 2 | 2 | 0 | 0 |
| 1 | 2 | 2 | 1 | 1 |
| 2 | 2 | 2 | 3 | 3 |
| 3 | 2 | 2 | 4 | 4 |
| 4 | 2 | 2 | 5 | 6 |
| 5 | 2 | 2 | 7 | 7 |
| 6 | 2 | 2 | 8 | 8 |
| 7 | 2 | 2 | 9 | 10 |
| 8 | 2 | 4 | 11 | 11 |
| 9 | 2 | 4 | 12 | 12 |
| 10 | 2 | 4 | 13 | 14 |
| 11 | 4 | 4 | 14 | 15 |
| 12 | 4 | 4 | 16 | 17 |
| 13 | 4 | 4 | 17 | 18 |
| 14 | 4 | 4 | 18 | 19 |
| 15 | 4 | 4 | 20 | 21 |

The second embodiment is related to a first solution of the support of 16QAM for NPUSCH of release 17. The first solution is related to the extension of the TBS table.

The number of resource units (N_{RU}) is determined by the resource assignment (I_{RU}), as indicated in Table 11.

TABLE 11

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

The subcarriers to be used are different for different subcarrier spacings. For subcarrier of 3.75 KHz, only single-tone is supported and one of 48 subcarriers is used. The used subcarrier can be indicated by a 6-bits field. For subcarrier of 15 KHz, both single-tone and multiple-tone are supported. One or three or six or twelve of twelve subcarriers is used. The subcarriers to be used may be indicated as indicated in Table 12.

TABLE 12

| Subcarrier | |
|---|---|
| indication field (I_{SC} | Set of Allocated subcarrier(s) (N_{SC}) |
| 0-11 | I_{SC} |
| 12-15 | 3 (I_{SC} - 12) + {0, 1, 2} |
| 16-17 | 6 (I_{SC} - 16) + {0, 1, 2, 3, 4, 5} |
| 18 | {0, 1, 2, 3, 4, 5, 6, 7, 8, 9, 10, 11} |
| 19-63 | Reserved |

As can be seen from Table 12, each subcarrier indication field (I_{SC}) can be used to indicate the allocated subcarriers.

In particular, when I_{SC}=0 to 11, the allocated carrier can be calculated by N_{SC}=I_{SC}. For example, when I_{SC}=3, the allocated carrier is 3 (1 tone).

When I_{SC}=12 to 15, the allocated carriers can be calculated by N_{SC}=3 (I_{SC}−12)+{0, 1, 2}. For example, when I_{SC}=13, the allocated carriers are 3, 4 and 5 (3 tones).

When I_{SC}=16 to 17, the allocated carriers can be calculated by N_{SC}=6 (I_{SC}−16)+{0, 1, 2, 3, 4, 5}. For example, when I_{SC}=16, the allocated carriers are 0, 1, 2, 3, 4 and 5 (6 tones).

When I_{SC}=18, the allocated carriers are 0, 1, 2, 3, 4, 5, 6, 7, 8, 9, 10 and 11 (12 tones).

The TBS is determined by TBS index (I_{TBS}) and the resource assignment (I_{RU}).

The maximal TBS remains as in release 16 for NPUSCH. That is, the maximal TBS is smaller than 2536. The maximum TBS index (I_{TBS}) may be extended to 20 or 21. The resource assignment (I_{RU}) remains as ranging from 0 to 7. Table 13 indicates the Transport block size (TBS) table for NPUSCH for support of 16QAM, in which 1 ms ranges from 0 to 21. If the maximum TBS index (I_{TBS}) is extended to 20, the last line of the Table 13 is omitted.

TABLE 13

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |
| 14 | 256 | 552 | 840 | 1128 | 1416 | 1736 | 2280 | |
| 15 | 280 | 600 | 904 | 1224 | 1544 | 1800 | 2472 | |
| 16 | 328 | 632 | 968 | 1288 | 1608 | 1928 | | |
| 17 | 336 | 696 | 1064 | 1416 | 1800 | 2152 | | |
| 18 | 376 | 776 | 1160 | 1544 | 1992 | 2344 | | |
| 19 | 408 | 840 | 1288 | 1736 | 2152 | | | |
| 20 | 440 | 904 | 1384 | 1864 | 2344 | | | |
| 21 | 488 | 1000 | 1480 | 1992 | 2472 | | | |

As can be seen from Table 13, legacy TBS table (i.e. I_{TBS} from 0 to 13) is kept for compatibility with Release 16. That is, legacy UE can use a part of TBS table (Table 13) in which I_{TBS} is from 0 to 13. New items (i.e. I_{TBS} from 14 to 21) are added for the support of T6QAM (i.e. Qₘ=4) for new UE.

In release 16 NBIoT, MCS index (I_{MCS}) are represented by 4 bits. In release 17, MCS index (I_{MCS}) may also be represented by 4 bits. There can be two options for the number of MCS indices. For option 1, the same number as the number of MCS indices in release 16 is used, i.e. 14 MCS indices are used. For option 2, the number of MCS indices is extended to 16, i.e. 16 MCS indices (that can still be represented by 4 bits) are used.

The modulation order (Qₘ) is determined by MCS index (I_{MCS}) and resource assignment (I_{RU}). The number of MCS indices (I_{MCS}) can be 14 or 16. The resource assignment (I_{RU}) may range from 0 to 7.

When the number of MCS indices (I_{MCS}) is 14 and the resource assignment (I_{RU}) is 0 or 1 or 2 or 3 or 4, two options of the modulation order (Qₘ) are indicated in Table 14.

TABLE 14

| MCS | Modulation | Modulation |
|---|---|---|
| Index | Order (Qₘ) | Order (Qₘ) |
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 4 |
| 8 | 2 | 4 |
| 9 | 4 | 4 |
| 10 | 4 | 4 |
| 11 | 4 | 4 |
| 12 | 4 | 4 |
| 13 | 4 | 4 |

When the number of MCS indices (I_{MCS}) is 16 and the resource assignment (I_{RU}) is 0 or 1 or 2 or 3 or 4, two options of the modulation order (Qₘ) are indicated in Table 15.

TABLE 15

| MCS | Modulation | Modulation |
|---|---|---|
| Index | Order (Qₘ) | Order (Qₘ) |
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 4 |
| 8 | 2 | 4 |
| 9 | 2 | 4 |
| 10 | 2 | 4 |
| 11 | 4 | 4 |
| 12 | 4 | 4 |
| 13 | 4 | 4 |
| 14 | 4 | 4 |
| 15 | 4 | 4 |

When the number of MCS indices (I_{MCS}) is 14 and the resource assignment (I_{RU}) is 5, two options of the modulation order (Qₘ) are indicated in Table 16.

TABLE 16

| MCS | Modulation | Modulation |
|---|---|---|
| Index | Order (Qₘ) | Order (Qₘ) |
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 4 |
| 8 | 2 | 4 |
| 9 | 2 | 4 |
| 10 | 4 | 4 |
| 11 | 4 | 4 |
| 12 | 4 | 4 |
| 13 | 4 | 4 |

When the number of MCS indices (I_{MCS}) is 16 and the resource assignment (I_{RU}) is 5, two options of the modulation order (Qₘ) are indicated in Table 17.

TABLE 17

| MCS | Modulation | Modulation |
|---|---|---|
| Index | Order (Qₘ) | Order (Qₘ) |
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 2 |
| 8 | 2 | 4 |
| 9 | 2 | 4 |
| 10 | 2 | 4 |
| 11 | 2 | 4 |
| 12 | 4 | 4 |
| 13 | 4 | 4 |
| 14 | 4 | 4 |
| 15 | 4 | 4 |

When the number of MCS indices (I_{MCS}) is 14 and the resource assignment (I_{RU}) is 6, two options of the modulation order (Qₘ) are indicated in Table 18.

TABLE 18

| MCS | Modulation | Modulation |
|---|---|---|
| Index | Order (Qₘ) | Order (Qₘ) |
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 2 |
| 8 | 2 | 2 |
| 9 | 2 | 4 |
| 10 | 2 | 4 |
| 11 | 2 | 4 |
| 12 | 4 | 4 |
| 13 | 4 | 4 |

When the number of MCS indices (I_{MCS}) is 16 and the resource assignment (I_{RU}) is 6, two options of the modulation order (Qₘ) are indicated in Table 19.

TABLE 19

| MCS Index | Modulation Order (Qₘ) | Modulation Order (Qₘ) |
|---|---|---|
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 2 |
| 8 | 2 | 2 |
| 9 | 2 | 4 |
| 10 | 2 | 4 |
| 11 | 2 | 4 |
| 12 | 2 | 4 |
| 13 | 2 | 4 |
| 14 | 4 | 4 |
| 15 | 4 | 4 |

When the number of MCS indices (I_{MCS}) is 14 and the resource assignment (I_{RU}) is 7, two options of the modulation order (Qₘ) are indicated in Table 20.

TABLE 20

| MCS Index | Modulation Order (Qₘ) | Modulation Order (Qₘ) |
|---|---|---|
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 2 |
| 8 | 2 | 2 |
| 9 | 2 | 4 |
| 10 | 2 | 4 |
| 11 | 2 | 4 |
| 12 | 2 | 4 |
| 13 | 2 | 4 |

When the number of MCS indices (I_{MCS}) is 16 and the resource assignment (I_{RU}) is 7, two options of the modulation order (Qₘ) are indicated in Table 21.

TABLE 21

| MCS Index | Modulation Order (Qₘ) | Modulation Order (Qₘ) |
|---|---|---|
| (I_{MCS}) | Option A1 | Option A2 |
| 0 | 2 | 2 |
| 1 | 2 | 2 |
| 2 | 2 | 2 |
| 3 | 2 | 2 |
| 4 | 2 | 2 |
| 5 | 2 | 2 |
| 6 | 2 | 2 |
| 7 | 2 | 2 |
| 8 | 2 | 2 |
| 9 | 2 | 4 |
| 10 | 2 | 4 |
| 11 | 2 | 4 |
| 12 | 2 | 4 |
| 13 | 2 | 4 |
| 14 | 2 | 4 |
| 15 | 2 | 4 |

As an alternative way of determining the modulation order (Qₘ), the modulation order (Qₘ) may be determined by MCS index (I_{MCS}) and scaling factor K. If round (KI_{MCS})>I_{MCS,max}, Q_{M}=4. Otherwise, Q_{M}=2. For example, I_{MCS,max} is fixed to 13 or configured by higher layer to 13.

The scaling factor K is determined by the resource assignment (I_{RU}). For a first example, when I_{RU}=0 or 1 or 2 or 3 or 4, K=21/14; when I_{RU}=5, K=19/14; when I_{RU}=6, K=16/14; when I_{RU}=7, K=1. For a second example, when I_{RU}=0 or 1 or 2 or 3 or 4, K=21/16; when I_{RU}=5, K=19/16; when I_{RU}=6 or 7, K=1. For a third example, when I_{RU}=0 Or 1 or 2 or 3 or 4, K=22/14; when I_{RU}=5, K=19/14; when I_{RU}=6, K=16/14; when I_{RU}=7, K=1. For a fourth example, when I_{RU}=0 or 1 or 2 or 3 or 4, K=22/16; when I_{RU}=5, K=19/16; when I_{RU}=6 or 7, K=1.

The TBS index (I_{TBS}) is determined by MCS index (I_{MCS}) and resource assignment (I_{RU}). The number of MCS indices (I_{MCS}) can be 14 or 16. The resource assignment (I_{RU}) may range from 0 to 7. There are two options for determining the TBS index (I_{TBS}). For option B1, the TBS index is selected from a total of 21 TBS indices. For option B2, the TBS index is selected from a total of 22 TBS indices.

When the number of MCS indices (I_{MCS}) is 14 and the resource assignment (I_{RU}) is 0 or 1 or 2 or 3 or 4, two options of the TBS index (I_{TBS}) are indicated in Table 16.

TABLE 22

| | TBS Index (I_{TBS}) | TBS Index (I_{TBS}) |
|---|---|---|
| MCS Index | Option B1 (total | Option B2 (total |
| (I_{MCS}) | TBS = 21) | TBS = 22) |
| 0 | 0 | 0 |
| 1 | 2 | 2 |
| 2 | 3 | 3 |
| 3 | 5 | 5 |
| 4 | 6 | 6 |
| 5 | 8 | 8 |
| 6 | 9 | 9 |
| 7 | 11 | 11 |
| 8 | 12 | 13 |
| 9 | 14 | 14 |
| 10 | 15 | 16 |
| 11 | 17 | 17 |
| 12 | 18 | 19 |
| 13 | 20 | 20 |

When the number of MCS indices (I_{MCS}) is 16 and the resource assignment (I_{RU}) is 0 or 1 or 2 or 3 or 4, two options of the TBS index (I_{TBS}) are indicated in Table 23.

TABLE 23

| | TBS Index (I_{TBS}) | TBS Index (I_{TBS}) |
|---|---|---|
| MCS Index | Option B1 (total | Option B2 (total |
| (I_{MCS}) | TBS = 21) | TBS = 22) |
| 0 | 0 | 0 |
| 1 | 1 | 1 |
| 2 | 3 | 3 |
| 3 | 4 | 4 |
| 4 | 5 | 6 |
| 5 | 7 | 7 |
| 6 | 8 | 8 |
| 7 | 9 | 10 |
| 8 | 11 | 11 |
| 9 | 12 | 12 |
| 10 | 13 | 14 |
| 11 | 14 | 15 |
| 12 | 16 | 17 |
| 13 | 17 | 18 |
| 14 | 18 | 19 |
| 15 | 20 | 21 |

When the number of MCS indices (I_{MCS}) is 14 and the resource assignment (I_{RU}) is 5, the TBS index (I_{TBS}) is indicated in Table 24.

TABLE 24

| MCS Index | TBS Index |
|---|---|
| (I_{MCS}) | (I_{TBS}) |
| 0 | 0 |
| 1 | 1 |
| 2 | 3 |
| 3 | 4 |
| 4 | 5 |
| 5 | 7 |
| 6 | 8 |
| 7 | 10 |
| 8 | 11 |
| 9 | 12 |
| 10 | 14 |
| 11 | 15 |
| 12 | 16 |
| 13 | 18 |

When the number of MCS indices (I_{MCS}) is 16 and the resource assignment (I_{RU}) is 5, the TBS index (I_{TBS}) is indicated in Table 25.

TABLE 25

| MCS Index | TBS Index |
|---|---|
| (I_{MCS}) | (I_{TBS}) |
| 0 | 0 |
| 1 | 1 |
| 2 | 2 |
| 3 | 4 |
| 4 | 5 |
| 5 | 6 |
| 6 | 7 |
| 7 | 8 |
| 8 | 10 |
| 9 | 11 |
| 10 | 12 |
| 11 | 13 |
| 12 | 14 |
| 13 | 15 |
| 14 | 17 |
| 15 | 18 |

When the number of MCS indices (I_{MCS}) is 14 and the resource assignment (I_{RU}) is 6, the TBS index (I_{TBS}) is indicated in Table 26.

TABLE 26

| MCS Index | TBS Index |
|---|---|
| (I_{MCS}) | (I_{TBS}) |
| 0 | 0 |
| 1 | 1 |
| 2 | 2 |
| 3 | 3 |
| 4 | 5 |
| 5 | 6 |
| 6 | 7 |
| 7 | 8 |
| 8 | 9 |
| 9 | 10 |
| 10 | 11 |
| 11 | 13 |
| 12 | 14 |
| 13 | 15 |

When the number of MCS indices (I_{MCS}) is 16 and the resource assignment (I_{RU}) is 6, the TBS index (I_{TBS}) is indicated in Table 27.

TABLE 27

| MCS Index | TBS Index |
|---|---|
| (I_{MCS}) | (I_{TBS}) |
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 14 | 14 |
| 15 | 15 |

When the number of MCS indices (I_{MCS}) is 14 and the resource assignment (I_{RU}) is 7, the TBS index (I_{TBS}) is indicated in Table 28.

TABLE 28

| MCS Index | TBS Index |
|---|---|
| (I_{MCS}) | (I_{TBS}) |
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |

When the number of MCS indices (I_{MCS}) is 16 and the resource assignment (I_{RU}) is 7, the TBS index (I_{TBS}) is indicated in Table 29.

TABLE 29

| MCS Index | TBS Index |
|---|---|
| (I_{MCS}) | (I_{TBS}) |
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 14 | 14 |
| 15 | 15 |

It can be seen from Tables 22-29, the MCS index is represented by 4 bits and the number of the MCS indices can be 14 or 16. On the other hand, the number of the TBS index can be 21 or 22. Therefore, some of the TBS indices (0 to 20 or to 21) are selected.

As an alternative way of determining the TBS index (I_{TBS}), the TBS index (I_{TBS}) may be determined by MCS index (I_{MCS}) and scaling factor K. I_{TBS}=round (KI_{MCS}).

The scaling factor K is determined by the resource assignment (I_{RU}). For a first example, when I_{RU}=0 or 1 or 2 or 3 or 4, K=21/14; when I_{RU}=5, K=19/14; when I_{RU}=6, K=16/14; when I_{RU}=7, K=1. For a second example, when I_{R}=0 or 1 or 2 or 3 or 4, K=21/16; when I_{RU}=5, K=19/16; when I_{RU}=6 or 7, K=1. For a third example, when I_{RU}=0 or 1 or 2 or 3 or 4, K=22/14; when I_{RU}=5, K=19/14; when I_{RU}=6, K=16/14; when I_{RU}=7, K=1. For a fourth example, when I_{RU}=0 or 1 or 2 or 3 or 4, K=22/16; when I_{RU}=5, K=19/16; when I_{RU}=6 or 7, K=1.

In the above determinations of the modulation order (Qₘ) and the TBS index (I_{TBS}) according to the second embodiment, the modulation order (Qₘ) and the TBS index (I_{TBS}) are determined separately for the resource assignment (I_{RU}) being equal to 5 or 6 or 7. Alternatively, the modulation order (Qₘ) and the TBS index (I_{TBS}) may be determined as the same values for the resource assignment (I_{RU}) being equal to 5, 6 and 7. Table 30 indicates the determinations of the modulation order (Qₘ) and the TBS index (I_{TBS}) based on the MCS index (I_{MCS}) and the resource assignment (I_{RU}), in which the same values are determined for I_{RU} being equal to 1 or 2 or 3 or 4, and the same values are determined for I_{RU} being equal to 5 or 6 or 7.

TABLE 30

| | | |
|---|---|---|
| MCS | Modulation Order Qₘ | TBS Index I_{TBS} |

| Index | I_{RU} = | I_{RU} = | I_{RU} = | I_{RU} = |
|---|---|---|---|---|
| I_{MCS} | 0, 1, 2, 3, 4 | 5, 6, 7 | 0, 1, 2, 3, 4 | 5, 6, 7 |
| 0 | 2 | 2 | 0 | 0 |
| 1 | 2 | 2 | 2 | 1 |
| 2 | 2 | 2 | 3 | 2 |
| 3 | 2 | 2 | 5 | 3 |
| 4 | 2 | 2 | 6 | 4 |
| 5 | 2 | 2 | 8 | 5 |
| 6 | 2 | 2 | 9 | 6 |
| 7 | 2 | 2 | 11 | 7 |
| 8 | 2 | 2 | 12 | 8 |
| 9 | 4 | 2 | 14 | 9 |
| 10 | 4 | 2 | 15 | 10 |
| 11 | 4 | 2 | 17 | 11 |
| 12 | 4 | 2 | 18 | 12 |
| 13 | 4 | 2 | 20 | 13 |

The third embodiment is related to a second solution of the support of 16QAM for NPUSCH data transmission of release 17. The second solution is related to adjusting the number of resource units.

According to the third embodiment, the number of resource units (N_{RU}) is adjusted. The number of resource units is determined by the modulation order (Qₘ) in addition to the resource assignment (I_{RU}). In particular, when 16QAM is used, the number of resource units is scaled down.

Table 31 indicates the number of resource units according to the third embodiment.

TABLE 31

N_{RU}

| I_{RU} | Qₘ = 2 | Qₘ = 4 |
|---|---|---|
| 0 | 1 | / |
| 1 | 2 | 1 |
| 2 | 3 | / |
| 3 | 4 | 2 |
| 4 | 5 | / |
| 5 | 6 | 3 |
| 6 | 8 | 4 |
| 7 | 10 | 5 |

It can be seen from Table 31 that, when Qₘ is equal to 2, the number of resource units is 1, 2, 3, 4, 5, 6, 8 and 10 for the resource assignment (I_{RU}) of 0, 1, 2, 3, 4, 5, 6 and 7, respectively. When Qₘ is equal to 4, the number of resource units is 1, 2, 3, 4 and 5 for the resource assignment (I_{RU}) of 1, 3, 5, 6 and 7, respectively. As there are only 5 candidate numbers of resource units (i.e. 1 to 5) for Qₘ being equal to 4, it is enough to use only five resource assignments.

In Table 31, no value of N_{RU} is configured for the resource assignment (I_{RU}) being equal to 0, 2 and 4 when Qₘ is equal to 4. Alternatively, when Qₘ is equal to 4, the same value of N_{RU} as that for I_{RU} being equal to 1, 3 and 5 can be configured for I_{RU} being equal to 0, 2 and 4, respectively. Table 32 indicates the alternative number of resource units according to the third embodiment.

TABLE 32

N_{RU}

| I_{RU} | Qₘ = 2 | Qₘ = 4 |
|---|---|---|
| 0 | 1 | 1 |
| 1 | 2 | 1 |
| 2 | 3 | 2 |
| 3 | 4 | 2 |
| 4 | 5 | 3 |
| 5 | 6 | 3 |
| 6 | 8 | 4 |
| 7 | 10 | 5 |

BPSK and/or QPSK are assumed to be used in single-tone for coverage enhancement. Therefore, 16QAM is not suitable for single-tone. Under this assumption, 16QAM can be supported only in multiple-tone. A joint coding can be applied for subcarrier allocation and modulation order (Qₘ) for multiple-tone.

Table 33 indicates the joint coding of the modulation order (Qₘ) and allocated subcarriers for NPUSCH with Δf=15 kHz.

TABLE 33

| Subcarrier indication | Modulation | Set of Allocated |
|---|---|---|
| field (I_{SC}) | order Qₘ | subcarrier(s) (N_{SC}) |
| 0-11 | 2 | I_{SC} |
| 12-15 | | 3 (I_{SC} − 12) + {0, 1, 2} |
| 16-17 | | 6 (I_{SC} − 16) + {0, 1, 2, 3, 4, 5} |
| 18 | | {0, 1, 2, 3, 4, 5, 6, 7, 8, 9, 10, 11} |
| 19-22 | 4 | 3(I_{SC} − 19) + {0, 1, 2} |
| 23-24 | | 6(I_{SC} − 23) + {0, 1, 2, 3, 4, 5} |
| 25 | | {0, 1, 2, 3, 4, 5, 6, 7, 8, 9, 10, 11} |
| 26-63 | | Reserved |

As can be seen from Table 33, each subcarrier indication field (I_{SC}) can be used to indicate both the modulation order (Qₘ) and the allocated subcarriers.

In particular, when I_{SC}=0 to 11, the modulation order (Qₘ) is 2 (i.e. QPSK), and the allocated carrier can be calculated by N_{SC}=I_{SC}. For example, when I_{SC}=3, the allocated carrier is #3 (1 tone).

When I_{SC}=12 to 15, the modulation order (Qₘ) is 2 (i.e. QPSK), and the allocated carriers can be calculated by N_{SC}=3 (I_{SC}−12)+{0, 1, 2}. For example, when I_{SC}=13, the allocated carriers are #3, #4 and #5 (3 tones).

When I_{SC}=16 to 17, the modulation order (Qₘ) is 2 (i.e. QPSK), and the allocated carriers can be calculated by N_{SC}=6 (I_{SC}−16)+{0, 1, 2, 3, 4, 5}. For example, when I_{SC}=16, the allocated carriers are #0, #1 , #2 , #3 , #4 and #5 (6 tones).

When I_{SC}=18, the modulation order (Qₘ) is 2 (i.e. QPSK), and the allocated carriers are #0, #1 , #2 , #3 , #4 , #5 , #6 , #7 , #8 , #9 , #10 and #11 (12 tones).

When I_{SC}=19 to 22, the modulation order (Qₘ) is 4 (i.e. 16QAM), and the allocated carriers can be calculated by N_{SC}=3 (I_{SC}−19)+{0, 1, 2}. For example, when I_{SC}=21, the allocated carriers are #6, #7 and #8 (3 tones).

When I_{SC}=23 to 24, the modulation order (Qₘ) is 4 (i.e. 16QAM), and the allocated carriers can be calculated by N_{SC}=6 (I_{SC}−23)+{0, 1, 2, 3, 4, 5}. For example, when I_{SC}=24, the allocated carriers are #6, #7 , #8 , #9 , #10 and #11 (6 tones).

When I_{SC}=25, the modulation order (Qₘ) is 4 (i.e. 16QAM), and the allocated carriers are #0, #1 , #2 , #3 , #4 , #5 , #6 , #7 , #8 , #9 , #10 and #11 (12 tones).

It can be seen that state values 19 to 25 indicate that the modulation order (Qₘ) is 4 (i.e. 16QAM).

The legacy TBS table is maintained. TBS is determined by TBS index (I_{TBS}) and resource assignment (I_{RU}). Table 34 indicates the Transport block size (TBS) table for NPUSCH according to the third embodiment.

TABLE 34

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | 1224 |
| 8 | 120 | 256 | 392 | 536 | 680 | 808 | 1096 | 1384 |
| 9 | 136 | 296 | 456 | 616 | 776 | 936 | 1256 | 1544 |
| 10 | 144 | 328 | 504 | 680 | 872 | 1000 | 1384 | 1736 |
| 11 | 176 | 376 | 584 | 776 | 1000 | 1192 | 1608 | 2024 |
| 12 | 208 | 440 | 680 | 1000 | 1128 | 1352 | 1800 | 2280 |
| 13 | 224 | 488 | 744 | 1032 | 1256 | 1544 | 2024 | 2536 |

Table 34 is the same as Table 5.

The TBS index (I_{TBS}) is determined by MCS index (I_{MCS}). For example, I_{TBS}=I_{MCS}.

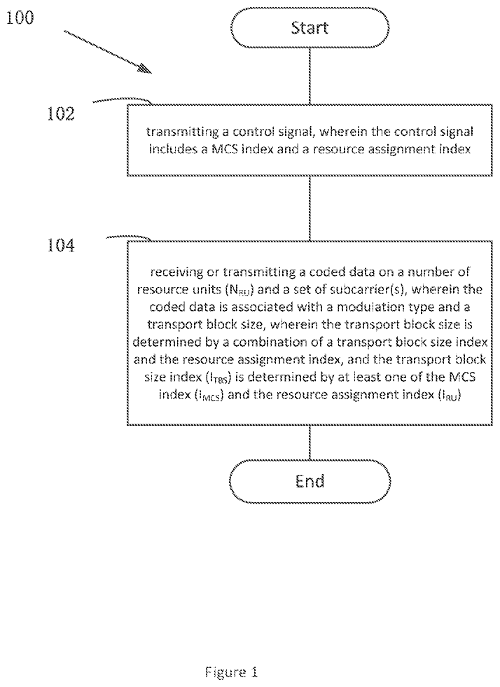

FIG. 1 is a schematic flow chart diagram illustrating an embodiment of a method 100 according to the present application. In some embodiments, the method 100 is performed by an apparatus, such as a base unit. In certain embodiments, the method 100 may be performed by a processor executing program code, for example, a microcontroller, a microprocessor, a CPU, a GPU, an auxiliary processing unit, a FPGA, or the like.

The method 100 may include 102 transmitting a control signal, wherein the control signal includes a MCS index and a resource assignment index and 104 receiving or transmitting a coded data on a number of resource units (N_{RU}) and a set of subcarrier(s), wherein the coded data is associated with a modulation type and a transport block size, wherein the transport block size is determined by a combination of a transport block size index and the resource assignment index, and the transport block size index (I_{TBS}) is determined by at least one of the MCS index (I_{MCS}) and the resource assignment index (I_{RU}).

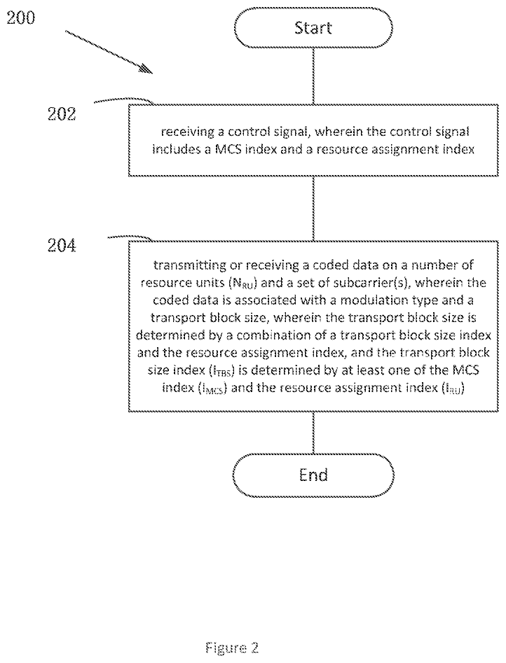

FIG. 2 is a schematic flow chart diagram illustrating a further embodiment of a method 200 according to the present application. In some embodiments, the method 200 is performed by an apparatus, such as a remote unit. In certain embodiments, the method 200 may be performed by a processor executing program code, for example, a microcontroller, a microprocessor, a CPU, a GPU, an auxiliary processing unit, a FPGA, or the like.

The method 200 may include 202 receiving a control signal, wherein the control signal includes a MCS index and a resource assignment index; and 204 transmitting or receiving a coded data on a number of resource units (N_{RU}) and a set of subcarrier(s), wherein the coded data is associated with a modulation type and a transport block size, wherein the transport block size is determined by a combination of a transport block size index and the resource assignment index, and the transport block size index (I_{TBS}) is determined by at least one of the MCS index (I_{MCS}) and the resource assignment index (I_{RU}).

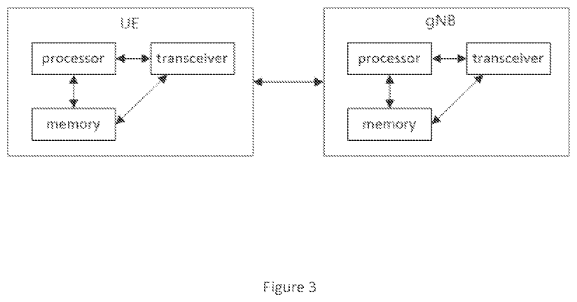

FIG. 3 is a schematic block diagram illustrating apparatuses according to one embodiment.

Referring to FIG. 3, the UE (i.e. the remote unit) includes a processor, a memory, and a transceiver. The processor implements a function, a process, and/or a method which are proposed in FIG. 2. The eNB (i.e. base unit) includes a processor, a memory, and a transceiver. The processors implement a function, a process, and/or a method which are proposed in FIG. 1. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1-16. (canceled)

17. A remote unit comprising a transceiver, the transceiver is configured to:
receive a control signal, wherein the control signal includes a modulation and coding scheme (MCS) index and a resource assignment index; and
perform one or more of to transmit or receive a coded data on a number of resource units and a set of one or more subcarriers, wherein the coded data is associated with a modulation type and a transport block size,
wherein the transport block size is determined by a combination of a transport block size index and the resource assignment index, and the transport block size index is determined by at least one of the MCS index and the resource assignment index.

18. The remote unit of claim 17, wherein the transport block size index is further determined by a scaling factor.

19. The remote unit of claim 17, wherein the modulation type is determined by the MCS index and the resource assignment index.

20. The remote unit of claim 19, wherein the modulation type is further determined by a scaling factor.

21. The remote unit of claim 20, wherein the scaling factor is determined by the resource assignment index.

22. The remote unit of claim 17, wherein the number of resource units is determined by the resource assignment index and the modulation type.

23. The remote unit of claim 17, wherein the control signal further includes a first field, the first field indicates the modulation type and the set of one or more subcarriers.

24. The remote unit of claim 23, wherein the first field includes 6 bits, and wherein at least state values 19 to 25 indicate the modulation type being 16-quadrature amplitude modulation (16QAM).

25. A base unit, comprising a transceiver, the transceiver is configured to:
transmit a control signal, wherein the control signal includes a modulation and coding scheme (MCS) index and a resource assignment index; and
perform one or more of to receive or transmit a coded data on a number of resource units and a set of one or more subcarriers, wherein the coded data is associated with a modulation type and a transport block size,
wherein the transport block size is determined by a combination of a transport block size index and the resource assignment index, and the transport block size index is determined by at least one of the MCS index and the resource assignment index.

26. The base unit of claim 25, wherein the transport block size index is further determined by a scaling factor.

27. The base unit of claim 25, wherein the modulation type is determined by the MCS index and the resource assignment index.

28. The base unit of claim 27, wherein the modulation type is further determined by a scaling factor.

29. The base unit of claim 28, wherein the scaling factor is determined by the resource assignment index.

30. The base unit of claim 25, wherein the number of resource units is determined by the resource assignment index and the modulation type.

31. The base unit of claim 25, wherein the control signal further includes a first field, the first field indicates the modulation type and the set of one or more subcarriers.

32. The base unit of claim 31, wherein the first field includes 6 bits, and wherein at least state values 19 to 25 indicate the modulation type being 16-quadrature amplitude modulation (16QAM).

33. A method comprising:
receiving a control signal, wherein the control signal includes a modulation and coding scheme (MCS) index and a resource assignment index; and
performing one or more of transmitting or receiving a coded data on a number of resource units and a set of one or more subcarriers, wherein the coded data is associated with a modulation type and a transport block size,
wherein the transport block size is determined by a combination of a transport block size index and the resource assignment index, and the transport block size index is determined by at least one of the MCS index and the resource assignment index.

34. The method of claim 33, wherein the transport block size index is further determined by a scaling factor.

35. The method of claim 33, wherein the modulation type is determined by the MCS index and the resource assignment index.

36. The method of claim 35, wherein the modulation type is further determined by a scaling factor.
